(19) United States
(12) Patent Application Publication
(10) Pub. No.: US 2009/0219964 A1
(43) Pub. Date: Sep. 3, 2009

(54) LASER DIODE DRIVER

(76) Inventors: Dror Yossi, Ramat Gan (IL); Gez Arie, Netanyya (IL)

Correspondence Address: David A. Novais;Patent Legal Staff, Eastman Kodak Company, 343 State Street, Rochester, NY, 14650-2201, US

(21) Appl. No.: 12/040,943

(22) Filed: Mar. 3, 2008

(51) Int. Cl. H01S 3/00

(52) U.S. Cl. 372/38.02

(57) ABSTRACT

An apparatus for driving a laser diode (10) by utilizing power means to activate the laser diode in short time includes a first voltage source (13) used during transient period of the laser diode operation. A second voltage source (12) equipped with lower voltage than the first voltage source (13) for supplying voltage power to the laser diode (10) during continuous operation of the laser diode. In one embodiment the first voltage source (13) is formed by amplifying second voltage source (12) for a short period of time utilizing a voltage boost control (14) circuit.

### FIELD OF THE INVENTION

The present invention relates to activating a laser diode by applying a high current during a transient rise time for the laser, and a lower voltage during operation of the laser.

### BACKGROUND OF THE INVENTION

A common electrical circuit to start a laser diode is shown in FIG. 1. A prior art electrical circuit design for a laser diode includes a voltage source 12, which is applied to start laser diode 10 as well as to supply the power required for conducting continuous operation of the laser diode.

A computer 18 initiates transmission of digital data to be imaged using laser diode 10. The data is supplied in synchronization with voltage source 12 through a digital control unit 15, typically a field programmable gate array (FPGA). The current supplied to the laser diode 10 is controlled by current control unit 17.

Because of the expense of laser diodes used in printing heads it is desirable to extend the life expectancy of the laser diodes. Some of the factors which may contribute to the shorter life expectancy for the diodes includes high operating temperatures and rough voltage transitions.

### SUMMARY OF THE INVENTION

Briefly, according to one aspect of the present invention an apparatus for driving a laser diode includes a first voltage source for powering the laser diode during a transient period of operation of the laser diode. A second voltage source, having a lower voltage than the first voltage source, powers the laser diode during continuous operation of the laser diode.

The present invention describes an apparatus and method for invoking a laser diode having a short rise/fall time while maintaining high system power efficiency. In one embodiment, the invention utilizes two different power voltage sources and one current drive module in conjunction with the laser diodes. A higher power voltage source is used during the transient rise time, and thus, for a short period. Once the laser diode is energized, the lower power voltage source is used for continuous laser diode operation.

Using two power supply sources, the higher power supply source level will be used to drive the current during the transient time of the laser diode operation, at the stage of starting the laser diode, and not during normal continuous laser diode operation. During the normal operation of the laser diode a lower power supply source will be used. The use of the dual power supply sources described above is advantageous. The use of high power supply source for a short period of time for starting the laser diode, and the lower power supply source for continuous operation of the laser diode, have a major role in extending the life expectancy of the laser diode.

Additional features and advantages of the invention will become apparent from the following drawings and description.

### BRIEF DESCRIPTION OF THE DRAWINGS

FIG. 1 is a prior art schematic illustrating a laser diode voltage driver control;

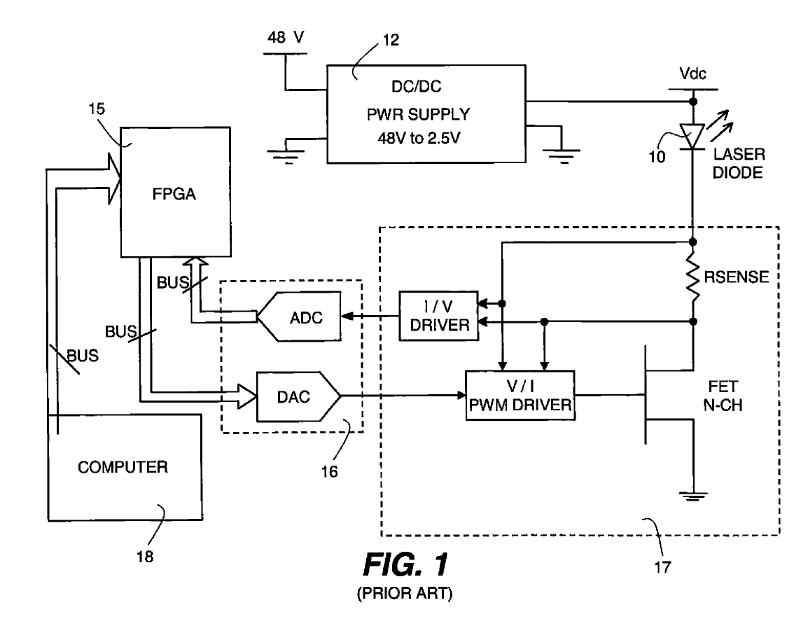

FIG. 2 is a schematic illustrating a laser diode dual voltage driver control each using a dedicated power supply external power supply;

FIG. 3 is a schematic illustrating a laser diode dual voltage driver control using a single external power supply for both voltage drivers; and

FIG. 4 is a schematic illustrating laboratory results for laser driver power supply simulation.

### DETAILED DESCRIPTION OF THE INVENTION

The invention discloses methods and apparatus for a laser diode driver. A laser driver, according to the present invention, has the following advantages:
a) The laser driver has a short rise time, typically less than 250 nanoseconds, using a high power voltage source.
b) The life expectancy of the laser diode power voltage source is extended by using a lower power voltage source than the one applied for starting the laser diode, during the continuous operation of the laser diode.
c) A smooth transient of current through the diode prevents high temperature from developing in the diode.

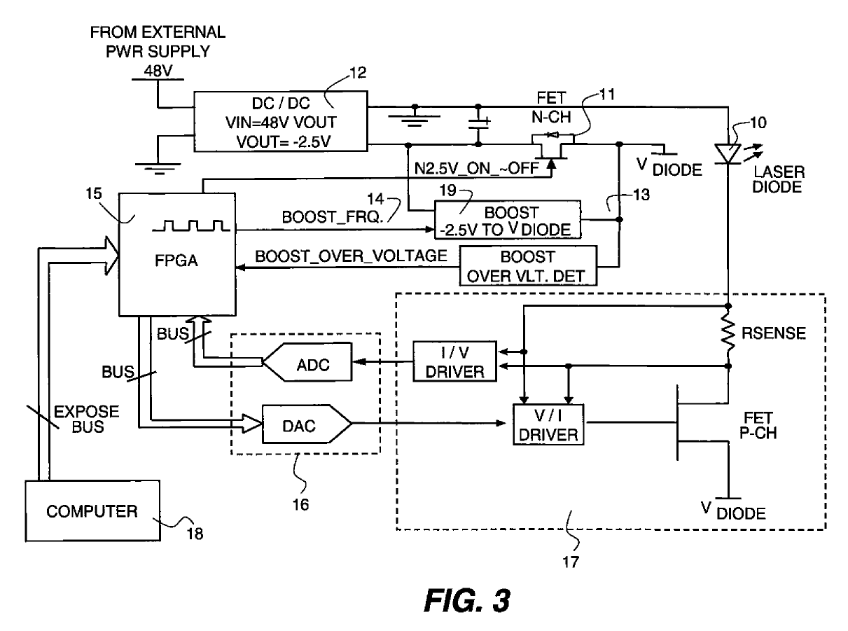

Referring to FIG. 3, computer 18 sends data via the expose bus to be imaged by laser diode 10. Laser diode 10 is started by the transient voltage source 13. The level of the transient voltage 13 is controlled by the digital control unit 15, which applies the required voltage level (usually between −3 v to −5 v) through the voltage boost control line 14 activating voltage boost circuit 19, synchronized with the data received from computer 18. In parallel, digital control unit 15 controls the digital to analog converter 16, to apply the required voltage level for starting laser diode 10. After laser diode 10 is started, digital control unit 15 opens switch 11 to connect external voltage source 12 to supply the voltage laser diode 10 for continuous diode operation, typically in voltage levels of −2.5 v.

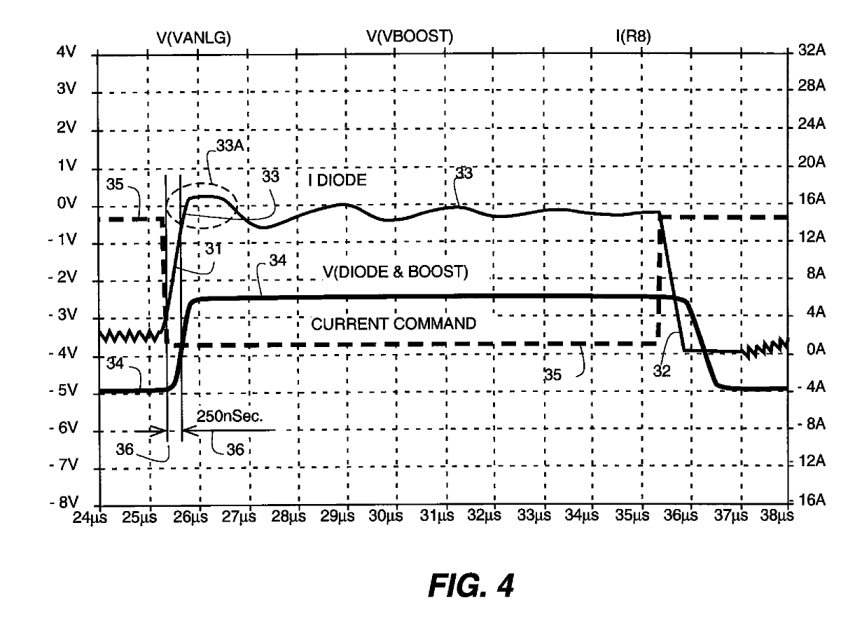

FIG. 4 shows voltage and current curves at the boost circuit 19, shown in FIG. 3, during operation of the voltage for laser diode 10. An advantage in this configuration is the generation of a smooth transition between the transient voltage and continuous voltage sources applied on the laser diode 10. The smooth voltage transition extends the life expectancy of the laser diode 10.

In order to achieve a smooth transient current 33 and smooth transient voltage 34, good timing synchronization should be achieved between the current command 35, triggered by the image data sent by computer 18, and the activation or deactivation of the boost circuit 19. Good synchronization will result in controlling the rise time value 31 and the current overshoot profile 33A developed on laser diode 10. The current overshoot profile 33A is essentially characterized by two factors: the current slew rate (measured by current value divided by the rise time value 31) and the switching point to the voltage source 12, used during continuous operation of laser diode 10.

At the time current command 35 is detected the boost circuit is already at the state of maximum duty cycle value, according to the setting received from digital control unit 15. At this point, high voltage values are applied to laser diode 10, enabling the smooth transient current 33 to reach to maximum values in a very short rise time 31. FIG. 4 shows a measured rise time 36 for a current increase from 0 A to 15 A to be achieved in 250 nanoseconds.

Just before the current values reaches the maximum value, the continuous voltage source 12 takes control. FIG. 4 shows the smooth transition between the two voltage sources as it is indicated in the charts showing smooth transient current 33 and smooth transient voltage 34.

When the current command 35 is off, the current in the diode falls as well, fall time 32 is measured at approximately 250 nanoseconds. At this stage the boost circuit 19 will start reloading again. The boost circuit 19 is used for supplying current to laser diode 10 only during rise time 31, following that the current will be supplied by the continuous voltage source 12.

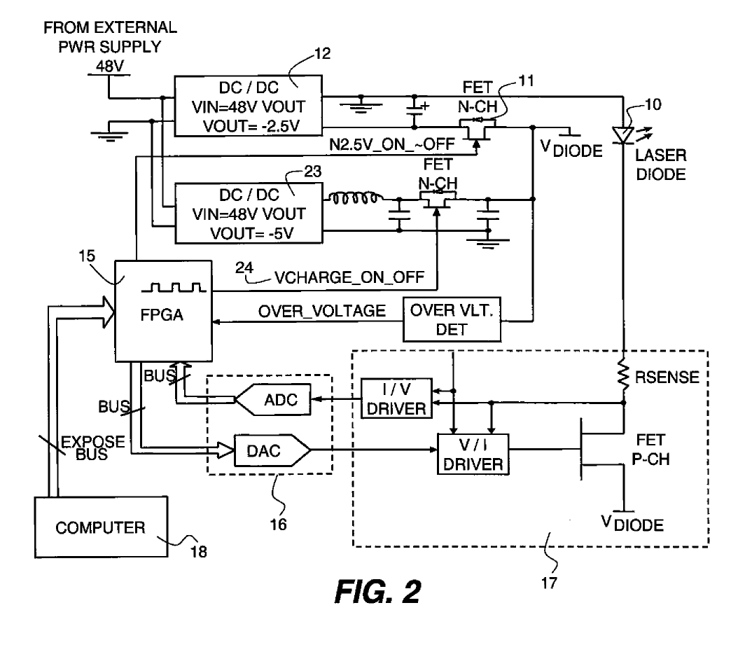

FIG. 3 shows transient voltage source 13 generated by the same external power supply, amplified by a voltage boost circuit 19. FIG. 2 depicts use of two distinct power supplies, external voltage source 12 for supplying continuous voltage lower than the voltage generated by power supply 23 for transient voltage purpose. The switching between the two power supplies is performed by opening switch 11 and closing switch 24 for transient voltage selection. The activation of voltage source 12 is done by closing switch 11 and opening switch 24.

The invention has been described in detail with particular reference to certain preferred embodiments thereof, but it will be understood that variations and modifications can be effected within the scope of the invention.

### PARTS LIST

10 laser diode
11 switch
12 voltage source
13 transient voltage source
14 voltage boost control line
15 digital control unit
16 digital to analog converter
17 current control unit
18 computer
19 boost circuit
23 transient power supply
24 switch
31 rise time value
32 fall time
33 smooth transient current
33A current overshoot profile
34 smooth transient voltage
35 current command
36 measured rise time

1. An apparatus for driving a laser diode comprising:
a first voltage source for powering said laser diode during a transient period of operation of said laser diode; and
a second voltage source, having a lower voltage than said first voltage source, for powering said laser diode during continuous operation of said laser diode.

2. The apparatus of claim 1 wherein application of said first voltage to said laser is synchronized with data imaged by said laser diode.

3. The apparatus of claim 1 wherein said application of second voltage to said laser diode is synchronized with data imaged by said laser diode.

4. The apparatus of claim 1 wherein said first voltage is produced by boosting said second voltage source.

5. The apparatus of claim 1 wherein said first voltage is positive.

6. The apparatus of claim 1 wherein said first voltage is negative.

7. The apparatus of claim 1 wherein said second voltage is 3 to 10 volts.

8. The apparatus of claim 5 wherein said first voltage is +1.5 to +3 volts.

9. The apparatus of claim 6 wherein said first voltage is −3 to −10 volts.

10. A method for driving a laser diode comprising:
applying a first voltage to said laser diode during start up of said laser diode;
applying a second voltage to said laser diode during operation of said laser diode; and
wherein said first voltage is higher than said second voltage.

11. A method for driving a laser diode comprising:
applying a first voltage during operation of said laser diode; and
applying a second voltage, in series with said first voltage, during start up of said laser diode.
